(19) United States
(12) Patent Application Publication
(10) Pub. No.: US 2019/0110506 A1
(43) Pub. Date: Apr. 18, 2019

(54) MIX FOR FRIED FOOD BATTER

(71) Applicant: NISSHIN FOODS INC., Tokyo (JP)

(72) Inventors: Mie OBARA, Tokyo (JP); Michihiro SAKAKIBARA, Tokyo (JP)

(21) Appl. No.: 16/087,905

(22) PCT Filed: May 26, 2017
(86) PCT No.: PCT/JP2017/019668

§ 371 Date: Sep. 24, 2018

(30) Foreign Application Priority Data
May 27, 2016 (JP) 2016-105895

(51) Int. Cl. A23L 7/157; A23L 5/10

(52) U.S. Cl. CPC A23L 7/157; A23V 2002/00; A23L 5/11

(57) ABSTRACT

A mix for fried food enables production of a fried food having favorable appearance and texture with less oil splattering during cooking even when using little oil with a shallow cooking utensil. The mix for fried food contains a wheat flour, a cereal flour that is not a wheat flour in an amount of 0.5-50 mass %, an emulsifier in an amount of 0.3-10 mass %, and a leavening agent in an amount of 0.05 to 5 mass %. The cereal flour that is not a wheat flour is preferably at least one selected from rice flour, barley flour, rye flour, and sorghum flour. An example of a method for producing a fried food using the mix for fried food is a method including mixing the mix for fried food with water to obtain a batter liquid and cooking in oil an ingredient to which the batter liquid is attached.

### TECHNICAL FIELD

The present invention relates to a mix for fried food that enables production of a fried food having favorable appearance and texture even when using only a small amount of oil for the production.

### BACKGROUND ART

Fried foods refer to foods that are obtained by cooking various ingredients in oil with heat, and a coating material is attached to the ingredient before cooking in oil in many cases, except for cases of french fried foods (deep-fried foods without batter or breading), etc. As a result of heating the ingredient with the coating material attached thereto in hot oil, water contained at or near the surface of the coating material is substituted with oil, and the resulting fried food has a coating having unique texture and flavor with crispness, while the ingredient has a condensed savory taste with its inside well cooked as if it were steamed with water contained in the ingredient itself.

To produce a fried food, a large amount of oil is necessary in order to minimize a decrease in oil temperature that occurs when a food at a low temperature is put into an oil bath containing hot oil and thereby avoid problems such as insufficient heating of the ingredient. However, a large amount of oil smoke is generated from a large amount of hot oil and stains a kitchen, and thus, there is demand for a technique that makes it possible to produce a fried food using a small amount of oil, which generates a relatively small amount of oil smoke. Moreover, conventionally, oil that was used to cook a fried food is not disposed of but is stored and reused the next time a fried food is cooked. However, due to, for example, the reluctance to use oil that is attributed to a recent increase in health awareness, opportunities for deep-flying are decreasing in ordinary households and the like. In such a condition, the storage period of used oil is prolonged, which leads concern about deterioration of the quality of such oil. For this reason, oil is often not stored but disposed of, after having been used only once, and this is a problem that may be linked to food waste. In this respect, if a fried food can be produced using a small amount of oil, it is advantageous in view of suppressing food waste.

In the case where a fried food is produced with a small amount of oil, a plurality of ingredients are likely to be densely present in the small amount of oil. When cooking in oil is performed in this state, pieces of the fried food may bind together depending on the type of the fried food, resulting in problems such as a poor appearance of the produced fried food. In particular, karaage (Japanese deep-fried chicken) is generally produced by a method in which a plurality of pieces of meat, which are the ingredient, are dredged with a coating material and cooked in oil at one time. Unfortunately, by such a method, the pieces of karaage are likely to bind together via their coatings partly because pieces of meat as the ingredient relatively easily bind together. Patent Literatures 1 and 2 disclose improved technologies with respect to a coating material in order to address such a problem peculiar to karaage. Patent Literature 1 discloses a karaage powder containing a wheat flour and a soybean flour as a cereal flour that is not a wheat flour, the soybean flour having a particle diameter and a nitrogen solubility index NSI within respective specific ranges. Patent Literature 2 discloses a karaage powder containing a Durum wheat flour having a particle diameter within a specific range. In view of preventing binding of karaage pieces, the karaage powders disclosed in Patent Literatures 1 and 2 are designed to intentionally reduce the binding properties of coatings that are to be obtained as a result of cooking in oil, and partly due to the effects of this design, a fried food having satisfactory appearance and texture cannot be obtained even when these karaage powders are used.

Patent Literatures 3 to 5 mainly disclose improved technologies for obtaining a fried food by a method including mixing a solid coating material with water to prepare a batter liquid, attaching the batter liquid to an ingredient, and cooking the resulting ingredient in oil, rather than a method including attaching a solid coating material directly to an ingredient and cooking the resulting ingredient in oil. An example of the fried food that is produced using such a batter liquid is tempura. In the case where tempura is produced using a plurality of pieces of an ingredient, a common procedure is to attach the batter liquid to the pieces of the ingredient one at a time and, immediately after that, cook each piece in oil, and thus, a plurality of pieces of the ingredient with a coating material attached thereto are seldom cooked collectively in oil at one time, unlike in the case of karaage. Therefore, pieces of tempura hardly bind together. Instead, in the case of tempura, since the coating that covers each piece of the ingredient is relatively thick due to the use of a batter liquid, it is necessary to be careful that the inside of the ingredient is thoroughly heated. In particular, in the case where tempura is produced using a small amount of oil, the oil temperature significantly decreases when a piece of the ingredient is put into the oil, and therefore insufficient heating of the ingredient is often a problem, of which care should be taken.

In Patent Literature 3, there is a description to the effect that, in order to shorten the time required for cooking in oil and prevent deterioration of tempura with time, a tempura mix contains a specific modified rice flour in addition to a wheat flour. In Patent Literature 4, there is a description to the effect that, in order to prevent deterioration of crispness of the coating with time, a batter liquid containing oil and fat in an amount of 20 to 60 wt % is used as a batter liquid to be attached to an ingredient before cooking in oil. Patent Literature 5 discloses, as a batter for producing a ready-cooked fried food product that is resistant to microwaving, a batter containing a substance selected from agar, carrageenan, starch, and the like and having a specific property and at least one selected from rice flour, high-amylose starch, and a leavening agent. However, Patent Literatures 3 to 5 make no mention whatsoever of production of a fried food using a small amount of oil, and even when a fried food is produced using a small amount of oil in combination with the coating material described in any of these documents, a fried food having satisfactory appearance and texture cannot be obtained.

### CITATION LIST

### Patent Literatures

Patent Literature 1: JP 2008-35791A
Patent Literature 2: JP 2008-35792A
Patent Literature 3: JP 2010-104246A
Patent Literature 4: JP H8-332033A
Patent Literature 5: JP H11-332495A

### SUMMARY OF INVENTION

### Technical Problem

It is an object of the present invention to provide a mix for fried food that enables production of a fried food having favorable appearance and texture with less frequent occurrence of oil splattering during cooking even when cooking in oil is performed using a small amount of oil with a shallow cooking utensil.

### Solution to Problem

In the case where a fried food is produced using a small amount of oil, the problem is a decrease in oil temperature that occurs as a result of putting an ingredient into the oil. In this case, a shallow oil bath like a frying pan, for example, is used instead of a deep oil bath, which is usually used in production of a fried food. However, in a shallow oil bath, both the ratio of the area of the interface between oil and air to the amount of oil in the oil bath and the ratio of the amount of an ingredient put into the oil to the amount of oil in the oil bath are large compared with those in a deep oil bath, and therefore, the extent of the decrease in oil temperature that occurs as a result of putting an ingredient into the oil is great. For example, in the case where a deep oil bath is used, it is said that the oil temperature decreases by about 5° C. per one piece of an ingredient that is put into the oil, and on the other hand, in the case where a shallow cooking utensil like a frying pan is used as the oil bath, the oil temperature may decrease by about 6 to 8° C. per one piece of an ingredient that is put into the oil. Thus, for example, if five or six pieces of an ingredient are put at one time into a shallow oil bath containing hot oil, the oil temperature will suddenly decrease by as much as almost 30 to 50° C. In that case, the ingredient will be cooked in oil at a low temperature, and problems may then arise such as tough texture, and insufficient cooking at the center portion of the pieces of the ingredient.

Moreover, another problem that exists in the case where a fried food is produced using a small amount of oil is frequent occurrence of oil splattering during cooking in oil. The reason for this is that, due to the use of a shallow oil bath like a frying pan in accordance with the small amount of oil, bumping of oil easily occurs during cooking in oil. There is a risk that the oil splattering during cooking in oil will cause a cook to be scalded, cause the kitchen to be stained, and cause other problems, and it is necessary to take preventive measures against such problems.

In view of the foregoing problems, the inventors of the present invention have conducted in-depth research on a coating material for fried food that enables cooking using a small amount of oil with a shallow cooking utensil. As a result, it has been found that, by using a coating material containing a wheat flour, which has been commonly used in a coating material conventionally, and also a cereal flour that is not a wheat flour in a specific amount, as well as an emulsifier and a leavening agent in specific amounts, a fried food having favorable appearance and texture can be produced with less frequent occurrence of oil splattering during cooking in oil even when cooking is performed using an amount of oil that is neither too much nor too little so that a material of fried food prepared by attaching the coating material to an ingredient can be just entirely immersed in the oil, and more specifically, a relatively small amount of oil such that the height from the bottom of the frying pan to the oil surface is about 2 cm, for example.

The present invention has been made on the basis of the above finding and provides a mix for fried food, comprising: a wheat flour; a cereal flour that is not a wheat flour in an amount of 0.5 to 50 mass %; an emulsifier in an amount of 0.3 to 10 mass %; and a leavening agent in an amount of 0.05 to 5 mass %.

The present invention also provides a method for producing a fried food, comprising using the mix for fried food of the present invention mentioned above, and specific examples of the fried food include tempura.

### Advantageous Effects of Invention

According to the present invention, even when cooking in oil is performed using a small amount of oil with a shallow cooking utensil in a conventional manner, less oil splattering occurs, and furthermore, a fried food having favorable appearance and texture can be easily produced.

### DESCRIPTION OF EMBODIMENTS

A mix for fried food of the present invention contains a wheat flour. As the wheat flour used in the present invention, any wheat flours that are usually used in coating materials for fried food can be used without limitation. Examples of such a wheat flour include strong flour, semi-strong flour, medium flour, weak flour, and Durum flour, and these wheat flours can be used singly or in combination of two or more. Among these wheat flours, weak flour is preferable because the texture of a resulting coating is not excessively tough.

The mix for fried food of the present invention contains a cereal flour that is not a wheat flour. As the cereal flour that is not a wheat flour used in the present invention, cereal flours derived from either plants with aerial stems or plants with underground stems may be used. Examples of the cereal flours derived from plants with aerial stems include rice flour, barley flour, rye flour, sorghum flour, corn flour, and bean flour, and examples of the cereal flours derived from plants with underground stems include potato flour and root crop flour. These cereal flours can be used singly or in combination of two or more. Among these cereal flours that are not a wheat flour, cereal flours derived from plants with aerial stems are preferable in light of further improvement in the appearance and texture of a fried food that is to be obtained using the mix for fried food. Rice flour, barley flour, rye flour, and sorghum flour are more preferable, and rice flour is even more preferable.

The amount of the cereal flour that is not a wheat flour contained in the mix for fried food of the present invention is 0.5 to 50 mass %, preferably 1 to 40 mass %, and more preferably 3 to 30 mass % with respect to the total mass of the mix. If the amount of the cereal flour that is not a wheat flour is less than 0.5 mass %, the wheat flour content becomes excessively large relative to the cereal flour content, and this may result in a tough texture of the fried food that is to be obtained using the mix for fried food. If the amount of the cereal flour that is not a wheat flour is more than 50 mass %, the texture of the fried food may be thickened and thus deteriorated.

Moreover, the amount of all the cereal flours, including both the wheat flour and the cereal flour that is not a wheat flour, contained in the mix for fried food of the present invention is preferably 60 to 99.5 mass % and more preferably 70 to 95 mass % with respect to the total mass of the mix.

The mix for fried food of the present invention contains an emulsifier. One of the functions of the emulsifier in the present invention is to suppress oil splattering during cooking in oil. As the emulsifier used in the present invention, any emulsifiers that are widely used for food, of course, including coating materials can be used without limitation. Examples of such an emulsifier include a glycerin fatty acid ester, a sucrose fatty acid ester, a sorbitan fatty acid ester, a propylene glycol fatty acid ester, lecithin, an organic acid monoglyceride, sodium stearoyl lactylate, and calcium stearoyl lactylate, and these emulsifiers can be used singly or in combination of two or more. Among these emulsifiers, a glycerin fatty acid ester with an HLB of 8 or greater and a sucrose fatty acid ester with an HLB of 8 or greater are preferable in light of further improvement in the texture of the fried food that is to be obtained using the mix for fried food.

The amount of the emulsifier contained in the mix for fried food of the present invention is 0.3 to 10 mass %, preferably 0.5 to 8 mass %, and more preferably 0.8 to 5 mass % with respect to the total mass of the mix. If the emulsifier content is less than 0.3 mass %, the effect of suppressing oil splattering during cooking in oil, which is ascribed to the emulsifier, is poor, and oil splattering may frequently occur during production of a fried food using the mix for fried food. Moreover, the resulting fried food may have a tough texture. On the other hand, if the emulsifier content is more than 10 mass %, the resulting fried food may have a poor appearance, and the taste of the fried food may be deteriorated since a flavor characteristic to the emulsifier is provided strongly.

The mix for fried food of the present invention contains a leavening agent. As the leavening agent used in the present invention, any leavening agents that are widely used for food, of course, including coating materials can be used without limitation. Examples of such a leavening agent include known leavening agents containing baking soda, such as baking soda, baking powder, and yeast powder. These leaving agents can be used singly or in combination of two or more. Among these leavening agents, a fast-acting baking powder is preferable in light of a crisp texture of the resulting coating and a favorable texture of the ingredient, particularly of meat, of the resulting fried food.

The amount of the leavening agent contained in the mix for fried food of the present invention is 0.05 to 5 mass %, preferably 0.1 to 3 mass %, and more preferably 0.2 to 1 mass % with respect to the total mass of the mix. If the leavening agent content is less than 0.05 mass %, the appearance of the fried food that is to be obtained using the mix for fried food may be poor, and the texture thereof may be tough. If the leavening agent content is more than 5 mass %, oil splattering may frequently occur during production of the fried food using the mix for fried food, and the texture of the produced fried food may be tough.

In addition to the above-described essential components (the wheat flour, the cereal flour that is not a wheat flour, the emulsifier, and the leavening agent), the mix for fried food of the present invention may also contain other components as necessary. Examples of the other components include starch; egg powder such as whole egg powder and albumen powder; thickeners; seasonings such as salt, powdered soy sauce, fermented seasonings, powdered miso, and amino acid; spices: flavoring agents; nutrients such as vitamins: coloring agents; and powdered fats and oils. These components can be used singly or in combination of two or more, in accordance with desired properties and the like of the fried food. The amount of the other components contained in the mix for fried food of the present invention can be adjusted as appropriate in accordance with desired properties and the like of the fried food and is not limited. The amount of the other components is preferably 30 mass % or less and more preferably 1 to 20 mass % with respect to the total mass of the mix.

The mix for fried food of the present invention can be used to produce a coated fried food in the same manner as for a conventional coating material. Examples of the fried food to which the present invention is applicable include breaded fried foods such as fried pork cutlet; tempura; karaage; and fried chicken. As the ingredient of the fried food to which the present invention is applied, various ingredients can be used, including meat, such as chicken, pork, beef, sheep meat, and goat meat; fish and shellfish, such as squid, prawns, and horse mackerels; and vegetables. Among them, meat and fish and shellfish which can be completely cooked in oil in a relatively short period of time are preferable.

The mix for fried food of the present invention is in the form of powder at normal temperature and pressure. When using the mix, the ingredient can be directly dredging with the mix as in the case where karaage is produced, for example. However, it is especially preferable to mix the mix with water to prepare a batter liquid and then attach the batter liquid to the ingredient, and the mix is more preferably used to produce tempura. As described above, in the case where the ingredient with the batter liquid attached thereto is cooked in a small amount of oil, there is concern over the tough texture of the resulting fried food, insufficient heating of the ingredient, and so on, because of the relatively large coating thickness due to the use of the batter liquid, and also because of a significant effect on the decrease in oil temperature upon putting the ingredient into the oil due to the small amount of oil. Such concern can be dispelled when a batter liquid prepared from the mix for fried food of the present invention is used, to thereby obtain a fried food having favorable appearance and texture advantageously with less frequent occurrence of oil splattering even when cooking using a small amount of oil with a shallow cooking utensil like a frying pan.

An example of a method for producing a fried food using the mix for fried food of the present invention includes mixing the mix with water to prepare a batter liquid and cooking in oil an ingredient to which the batter liquid is attached. As the water used to prepare the batter liquid, any water that can be used for food can be employed. The amount of water used can be adjusted as appropriate in accordance with desired properties and the like of the fried food. The amount of water used is usually, but not limited to, 150 to 300 parts by mass with respect to 100 parts by mass of the mix for fried food. The oil temperature during cooking in oil can be adjusted as appropriate in accordance with desired properties and the like of the fried food. The oil temperature is usually, but not limited to, 150 to 180° C. Any of vegetable oils and animal oils may be used as the oil for cooking in oil. Examples of the vegetable oils include salad oil, soybean oil, and sesame oil, and examples of the animal oils include lard and butter.

The method for cooking in oil that is performed in production of a fried food using the mix for fried food of the present invention is not limited, and frying in a large amount of oil (so-called deep-frying) may be used. However, the mix for fried food of the present invention more remarkably exhibits its effects when frying in a small amount of oil (in other words, shallow-frying) using a shallow cooking utensil (shallow oil bath), that is, pan-frying or sautéing is employed. The “shallow cooking utensil (shallow oil bath)” as used herein typically refers to a cooking utensil having a height of not greater than 50 mmm, the height being of a portion in which ingredients are to be accommodated and cooked (the length from the bottom to the top (upper opening), or the maximum length when a cooking utensil has an irregular length). A so-called frying pan, which is a type of cooking utensil, is included in the shallow cooking utensil. Moreover. “a small amount of oil” refers to an amount of oil satisfying the following condition: when an object to be cooked in oil (an ingredient with the mix for fried food attached thereto) is put in an oil bath, 90% or more of the surface area of the object is immersed in the oil, and also the minimum separation distance between the bottom of the oil bath and the object to be cooked in oil is not greater than 2 cm.

### EXAMPLES

Next, examples will be given in order to more specifically describe the present invention. However, the present invention is not limited to the examples below.

### Examples 1 to 25 and Comparative Examples 1 to 8

Materials shown in Tables 1 to 3 below were appropriately mixed to produce mixes for fried food of Examples and Comparative Examples. Details of the materials used were as follows:
Rice flour (“Le Marronnier” manufactured by Hinomoto Cereals Flour Milling Co., Ltd.)
Rye flour (“Alle Fine” manufactured by Nisshin Flour Milling Inc.)
Soybean flour (“Nikka Meat” manufactured by Nikka Oil Mills Co., Ltd.)
Emulsifier (sucrose fatty acid ester with an HLB of 8 or greater, “RYOTO Sugar Ester” manufactured by San-Ei Gen F.F.I., Inc.)
Emulsifier (glycerin fatty acid ester with an HLB of 8 or greater, “Poem DS-100A” manufactured by Riken Vitamin Co., Ltd.)
Leavening agent (“Baking Powder” manufactured by Nisshin Foods Inc.)
Weak flour (“Flour” manufactured by Nisshin Foods Inc.)

### Test Examples

160 parts by mass of water was added to and mixed with 100 parts by mass of the mix for fried food of each of Examples and Comparative Examples to prepare a batter liquid. Shelled prawns (Penaeus monodon: thickness about 1.2 cm) were provided as ingredients, and the prepared batter liquid was attached to the prawns to prepare ready-to-fry prawns (thickness about 1.5 cm). A frying pan with a diameter of 20 cm was used as the shallow cooking utensil. Salad oil was poured into the frying pan to a height of 2 cm from the bottom thereof, and heated. When the oil temperature reached 170° C., five ready-to-fry prawns, each of which had the batter liquid prepared from the same mix for fried food, were put into the salad oil at one time and cooked in oil for one and half minutes to produce five tempura prawns. For each of the mixes for fried food of Examples and Comparative Examples, five tempura prawns were produced in this manner.

The appearance and the texture of the tempura prawns immediately after production were evaluated by a panel of ten members according to the scoring scales below. Tables 1 to 3 below show the results (the average of the scores given by the ten members of the panel).

### Scoring Scale for Evaluation of Appearance

5: Sufficiently voluminous appearance with a favorable fluffy roughness.

4: Voluminous appearance with fluffy roughness in part.

3: Non-fluffy appearance but with roughness in part.

2: Non-fluffy appearance with rather insufficient roughness and volume.

1: Entirely smooth coating lacking in roughness and volume.

### Scoring Scale for Evaluation of Texture

5: Excellent coating with crispness and crunchiness.

4: Favorable coating with crispness.

3: Coating that is rather lacking in crispness.

2: Coating that is rather tough or rather soggy and has little crispness.

1: Poor coating that is too tough or very soggy and has no crispness.

TABLE 1

| | | | Ex. | | | | | | |
|---|---|---|---|---|---|---|---|---|---|
| | | | 1 | 2 | 3 | 4 | 5 | 6 | 7 |
| Composition | Cereal flour | Rice flour | 0.5 | 1 | 3 | 10 | 20 | 70 | — |
| of mix | that is not | Rye flour | — | — | — | — | — | — | 20 |
| (mass %) | wheat flour | Soybean | — | — | — | — | — | — | — |
| | | flour | | | | | | | |
| | Emulsifier | Sucrose | 1 | 1 | 1 | 1 | 1 | — | 1 |
| | | fatty acid | | | | | | | |
| | | ester | | | | | | | |
| | | Glycerin | — | — | — | — | — | 1 | — |
| | | fatty acid | | | | | | | |
| | | ester | | | | | | | |

| | Leavening agent | 0.5 | 0.5 | 0.5 | 0.5 | 0.5 | 0.5 | 0.5 |
|---|---|---|---|---|---|---|---|---|
| | Weak flour | Balance | Balance | Balance | Balance | Balance | Balance | Balance |
| | Total | 100 | 100 | 100 | 100 | 100 | 100 | 100 |
| Evaluation | Appearance of fried | 4.0 | 4.1 | 4.2 | 4.3 | 4.3 | 4.3 | 4.1 |
| | food | | | | | | | |
| | Texture of fried food | 3.6 | 3.9 | 4.2 | 4.5 | 4.5 | 4.5 | 4.4 |
| | | | Ex. | | | | Com. Ex. | |
| | | | 8 | 9 | 10 | 11 | 1 | 2 |
| Composition | Cereal flour that is not | Rice flour | — | 30 | 40 | 50 | 0.3 | 55 |
| of mix | wheat flour | Rye flour | — | — | — | — | — | — |
| (mass %) | | Soybean | 20 | — | — | — | — | — |
| | | flour | | | | | | |
| | Emulsifier | Sucrose | 1 | 1 | 1 | 1 | 1 | 1 |
| | | fatty acid | | | | | | |
| | | ester | | | | | | |
| | | Glycerin | — | — | — | — | — | — |
| | | fatty acid | | | | | | |
| | | ester | | | | | | |

| | | | | | | | |
|---|---|---|---|---|---|---|---|
| | Leavening agent | 0.5 | 0.5 | 0.5 | 0.5 | 0.5 | 0.5 |
| | Weak flour | Balance | Balance | Balance | Balance | Balance | Balance |
| | Total | 100 | 100 | 100 | 100 | 100 | 100 |
| Evaluation | Appearance of fried food | 3.9 | 4.2 | 4.2 | 4.1 | 3.2 | 3.3 |
| | Texture of fried food | 3.9 | 4.3 | 4.7 | 4.0 | 1.6 | 3.7 |

Examples and Comparative Examples shown in Table 1 differed from one another in terms of the content and the type of the cereal flour that is not a wheat flour. As shown in Table 1, in Examples, in which the content of the cereal flour that is not a wheat flour was within a specific range, specifically 0.5 to 50 mass %, the appearance and the texture of the produced fried food were favorable when compared with those in Comparative Examples, in which the content of the cereal flour that is not a wheat flour was outside this specific range. Thus, the effectiveness of this specific range is clear.

Moreover, a comparison of Examples 6 and 7 with Example 8 shows that rice flour and rye flour are more effective than soybean flour as the cereal flour that is not a wheat flour. Incidentally, a soybean flour is used as a cereal flour that is not a wheat flour in wheat flour-containing karaage powders disclosed in Patent Literatures 1 and 2. The karaage powder disclosed in each of Patent Literatures 1 and 2 is usually used by dredging an ingredient with the karaage powder as is, without preparing a batter liquid by mixing it with water. Soybean flour may possibly be effective as the cereal flour that is used together with the wheat flour in the manner of usage of a coating material as in Patent Literatures 1 and 2; however, it can be said that rice flour and rye flour are more effective than soybean flour in a manner of usage in which a batter liquid is used as a coating material as in Examples of the present invention.

It should be noted that, in all of Examples and Comparative Examples shown in Table 1, less oil splattering occurred during cooking in oil. This is probably due to the effect of the emulsifier mainly.

TABLE 2

| | | Ex. | | | | | | | | | Com. Ex. | |
|---|---|---|---|---|---|---|---|---|---|---|---|---|
| | | 12 | 13 | 14 | 5 | 15 | 16 | 17 | 18 | 3 | 4 | 5 |
| Composition | Rice flour | 20 | 20 | 20 | 20 | 20 | 20 | 20 | 20 | 20 | 20 | 20 |
| of mix | (Cereal flour that is not | | | | | | | | | | | |
| (mass %) | wheat flour) | | | | | | | | | | | |
| | Emulsifier | 0.3 | 0.5 | 0.7 | 1 | 3 | 5 | 8 | 10 | — | 0.1 | 12 |
| | (Sucrose fatty acid ester) | | | | | | | | | | | |
| | Leavening agent | 0.5 | 0.5 | 0.5 | 0.5 | 0.5 | 0.5 | 0.5 | 0.5 | 0.5 | 0.5 | 0.5 |
| | Weak flour | Balance | Balance | Balance | Balance | Balance | Balance | Balance | Balance | Balance | Balance | Balance |
| | Total | 100 | 100 | 100 | 100 | 100 | 100 | 100 | 100 | 100 | 100 | 100 |
| Evaluation | Appearance of fried food | 4.0 | 4.2 | 4.3 | 4.3 | 4.4 | 4.2 | 4.1 | 3.9 | 3.8 | 3.8 | 3.6 |
| | Texture of fried food | 3.5 | 3.9 | 4.2 | 4.5 | 4.3 | 4.1 | 3.9 | 3.6 | 2.7 | 2.8 | 3.0 |

Examples and Comparative Examples shown in Table 2 differed from one another in terms of the emulsifier content. As shown in Table 2, in Examples, in which the emulsifier content was within a specific range, specifically 0.3 to 10 mass %, the appearance and the texture of the produced fried food were favorable when compared with those in Comparative Examples, in which the emulsifier content was outside this specific range. Thus, the effectiveness of this specific range is clear.

It should be noted that, in both of Comparative Examples 3 and 4, oil splattering relatively frequently occurred during cooking in oil, because no or a too small amount of emulsifier was contained in the mix.

TABLE 3

| | | Ex. | | | | | | | | Com. Ex. | | |
|---|---|---|---|---|---|---|---|---|---|---|---|---|
| | | 19 | 20 | 21 | 5 | 22 | 23 | 24 | 25 | 6 | 7 | 8 |
| Composition | Rice flour | 20 | 20 | 20 | 20 | 20 | 20 | 20 | 20 | 20 | 20 | 20 |
| of mix | (Cereal flour that is not | | | | | | | | | | | |
| (mass %) | wheat flour) | | | | | | | | | | | |
| | Emulsifier | 1 | 1 | 1 | 1 | 1 | 1 | 1 | 1 | 1 | 1 | 1 |
| | (Sucrose fatty acid ester) | | | | | | | | | | | |
| | Leavening agent | 0.05 | 0.1 | 0.2 | 0.5 | 0.8 | 1 | 3 | 5 | — | 0.02 | 8 |
| | Weak flour | Balance | Balance | Balance | Balance | Balance | Balance | Balance | Balance | Balance | Balance | Balance |
| | Total | 100 | 100 | 100 | 100 | 100 | 100 | 100 | 100 | 100 | 100 | 100 |
| Evaluation | Appearance of fried food | 3.5 | 3.9 | 4.3 | 4.3 | 4.3 | 4.2 | 4.2 | 4.0 | 2.8 | 3.2 | 3.6 |
| | Texture of fried food | 3.3 | 3.9 | 4.5 | 4.4 | 4.2 | 4.0 | 3.6 | 3.3 | 2.9 | 3.1 | 2.8 |

Examples and Comparative Examples shown in Table 3 differed from one another in terms of the leavening agent content. As shown in Table 3, in the examples, in which the leavening agent content was within a specific range, specifically 0.05 to 5 mass %, the appearance and texture of the produced fried foods were favorable when compared with those in Comparative Examples, in which the leavening agent content was outside this specific range. Thus, the effectiveness of this specific range is clear.

It should be noted that, in Comparative Example 8, oil splattering relatively frequently occurred during cooking in oil despite the same emulsifier content as in Examples and another Comparative Example. This is probably due to the excessively high leavening agent content.

1. A mix for fried food, comprising: a wheat flour; a cereal flour that is not a wheat flour in an amount of 0.5 to 50 mass %; an emulsifier in an amount of 0.3 to 10 mass %; and a leavening agent in an amount of 0.05 to 5 mass %.

2. The mix for fried food according to claim 1,
wherein the cereal flour that is not a wheat flour is at least one selected from rice flour, barley flour, rye flour, and sorghum flour.

3. The mix for fried food according to claim 1, wherein the cereal flour that is not a wheat flour is contained in an amount of 1 to 40 mass %.

4. The mix for fried food according to claim 1, wherein the emulsifier is contained in an amount of 0.5 to 8 mass %.

5. A method for producing a fried food, comprising using the mix for fried food according to claim 1.

6. The method for producing a fried food according to claim 5, the method comprising: mixing the mix for fried food with water to obtain a batter liquid and cooking in oil an ingredient to which the batter liquid is attached.

7. The mix for fried food according to claim 2, wherein the cereal flour that is not a wheat flour is contained in an amount of 1 to 40 mass %.

8. The mix for fried food according to claim 2, wherein the emulsifier is contained in an amount of 0.5 to 8 mass %.

9. The mix for fried food according to claim 3, wherein the emulsifier is contained in an amount of 0.5 to 8 mass %.

10. The mix for fried food according to claim 7, wherein the emulsifier is contained in an amount of 0.5 to 8 mass %.

11. A method for producing a fried food, comprising using the mix for fried food according to claim 2.

12. A method for producing a fried food, comprising using the mix for fried food according to claim 3.

13. A method for producing a fried food, comprising using the mix for fried food according to claim 4.

14. A method for producing a fried food, comprising using the mix for fried food according to claim 7.

15. A method for producing a fried food, comprising using the mix for fried food according to claim 8.

16. A method for producing a fried food, comprising using the mix for fried food according to claim 9.

17. A method for producing a fried food, comprising using the mix for fried food according to claim 10.
